(19) United States
(12) Patent Application Publication
(10) Pub. No.: US 2024/0394252 A1
(43) Pub. Date: Nov. 28, 2024

(54) DATA ENRICHMENT USING PARALLEL SEARCH

(71) Applicant: Plaid Inc., San Francisco, CA (US)

(72) Inventors: Hansen QIU, New York, NY (US); Jackson CHEN, Oakland, CA (US); Jian TIAN, Fremont, CA (US); Josh ISENSTEIN, New York, NY (US); Kelvin DO, New York, NY (US); Nicholas SUNDIN, New York, NY (US); Seyoung KIM, New York, NY (US); Thomas WANG, San Jose, CA (US); Chaoyi ZHA, New York, NY (US); Yi HONG, Jersey City, NJ (US); Zak BENNETT, New York, NY (US); Zhongkun JIN, Ridgefield, CT (US)

(21) Appl. No.: 18/673,986

(22) Filed: May 24, 2024

Related U.S. Application Data
(60) Provisional application No. 63/504,153, filed on May 24, 2023.

(51) Int. Cl. G06F 16/2453; G06F 16/2458

(52) U.S. Cl. CPC G06F 16/24532; G06F 16/2468

(57) ABSTRACT

In some implementations, an enrichment engine may receive a first entry. The enrichment engine may generate a normalized first entry by using subword tokenization of the first entry. The enrichment engine may execute a plurality of searches concurrently, including: a first search configured to map a portion of the normalized first entry to a first result using regular expressions and fuzzy matching, a second search configured to provide the normalized first entry to a machine learning model in order to receive a second result, and a third search configured to map a vectorized version of the normalized first entry to a third result in a vector database. The enrichment engine may determine a selected result from the first result based on the first search, the second result based on the second search, or the third result based on the third search. The enrichment engine may return the selected result.

### RELATED APPLICATION

This application claims priority to U.S. Provisional Patent Application No. 63/504,153, filed May 24, 2023, which is incorporated herein by reference in its entirety.

### BACKGROUND

Structured data, such as event data and/or transactional data, often includes string entries describing each entry (e.g., each event or each transaction). Generally, the string entries are written in machine-friendly language rather than natural language.

### SUMMARY

Some implementations described herein relate to a system for data enrichment using a plurality of searches in parallel. The system may include one or more memories and one or more processors communicatively coupled to the one or more memories. The one or more processors may be configured to receive a set of structured data including at least a first entry. The one or more processors may be configured to execute the plurality of searches concurrently, wherein the plurality of searches comprises, a first search configured to map a portion of the first entry to a first result using regular expressions and fuzzy matching a second search configured to provide the first entry to a machine learning model in order to receive a second result a third search configured to map a vectorized version of the first entry to a third result in a vector database. The one or more processors may be configured to determine a selected result from the first result based on the first search, the second result based on the second search, or the third result based on the third search. The one or more processors may be configured to calculate a confidence level associated with the selected result. The one or more processors may be configured to output the selected result, including enhancement information for the first entry, and the confidence level.

Some implementations described herein relate to a method of data enrichment using a plurality of searches in parallel. The method may include receiving, at an enrichment engine, a set of structured data including at least a first entry. The method may include generating a normalized first entry by using subword tokenization of the first entry. The method may include executing, by the enrichment engine, the plurality of searches concurrently, wherein the plurality of searches comprises, a first search configured to map a portion of the normalized first entry to a first result using regular expressions and fuzzy matching a second search configured to provide the normalized first entry to a machine learning model in order to receive a second result a third search configured to map a vectorized version of the normalized first entry to a third result in a vector database. The method may include determining, by the enrichment engine, a selected result from the first result based on the first search, the second result based on the second search, or the third result based on the third search. The method may include returning the selected result including enhancement information for the first entry.

Some implementations described herein relate to a non-transitory computer-readable medium that stores a set of instructions for data enrichment. The set of instructions, when executed by one or more processors of a device, may cause the device to receive a set of structured data including at least a first entry. The set of instructions, when executed by one or more processors of the device, may cause the device to generate a normalized first entry by using subword tokenization of the first entry. The set of instructions, when executed by one or more processors of the device, may cause the device to determine a selected result, with enhancement information for the first entry, using one or more of regular expressions, fuzzy matching, or a machine learning model. The set of instructions, when executed by one or more processors of the device, may cause the device to calculate a confidence level associated with the selected result. The set of instructions, when executed by one or more processors of the device, may cause the device to return the selected result, including the enhancement information, and the confidence level.

### BRIEF DESCRIPTION OF THE DRAWINGS

FIGS. 1A-1C are diagrams of an example implementation relating to data enrichment using parallel search.

FIG. 2 is a diagram of an example environment in which systems and/or methods described herein may be implemented.

FIG. 3 is a diagram of example components of one or more devices of FIG. 2.

FIG. 4 is a flowchart of an example process relating to data enrichment using parallel search.

### DETAILED DESCRIPTION

The following detailed description of example implementations refers to the accompanying drawings. The same reference numbers in different drawings may identify the same or similar elements.

Structured data, such as event data and/or transactional data, often includes string entries describing each entry (e.g., each event or each transaction). Generally, the string entries are written in machine-friendly language rather than natural language. However, machine-friendly language is not user-friendly and does not translate well to audio for impaired users. Standardizing the string entries helps but consumes power and processing resources at a user device and is time-consuming. Additionally, standardization is best when using a database of names and/or locations, but this significantly increases memory overhead at the user device.

Remote data enrichment of a set of structured data, such as event data and/or transactional data, may leverage larger databases to improve accuracy and reduce memory overhead as compared with data enrichment performed at a user device. Additionally, remote data enrichment may be faster and more efficient as compared with data enrichment performed at the user device.

Some implementations described herein provide for using concurrent searches in data enrichment. As a result, accuracy is further increased because outputs from regular expressions (also referred to as “regexes”), machine learning models, and vector searches are combined. Performing the searches remotely is faster and more efficient as compared with performing the searches at a user device. Additionally, performing the searches concurrently decreases latency in returning enhancement information to the user device.

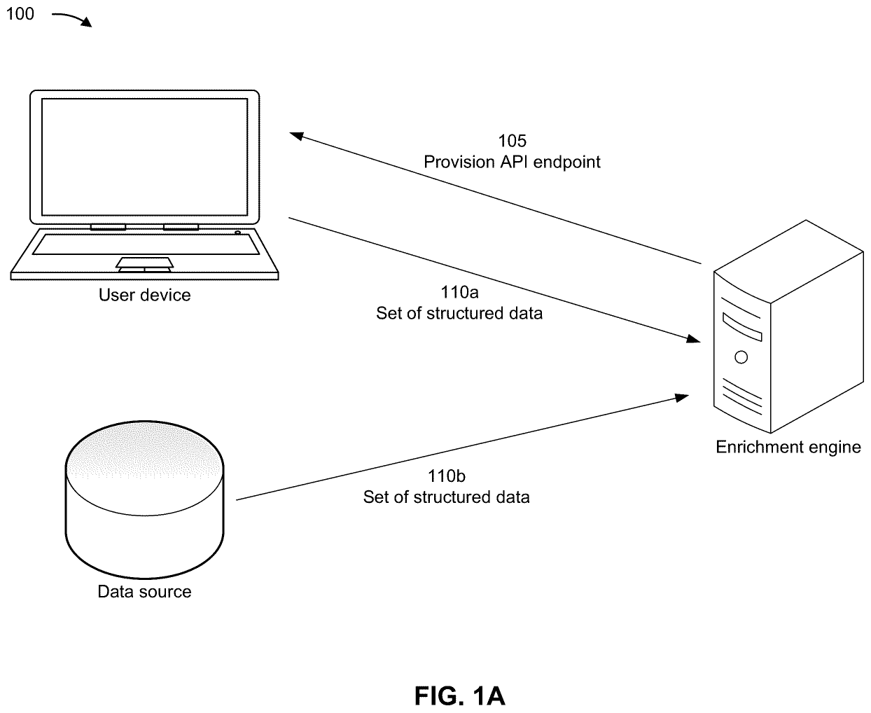

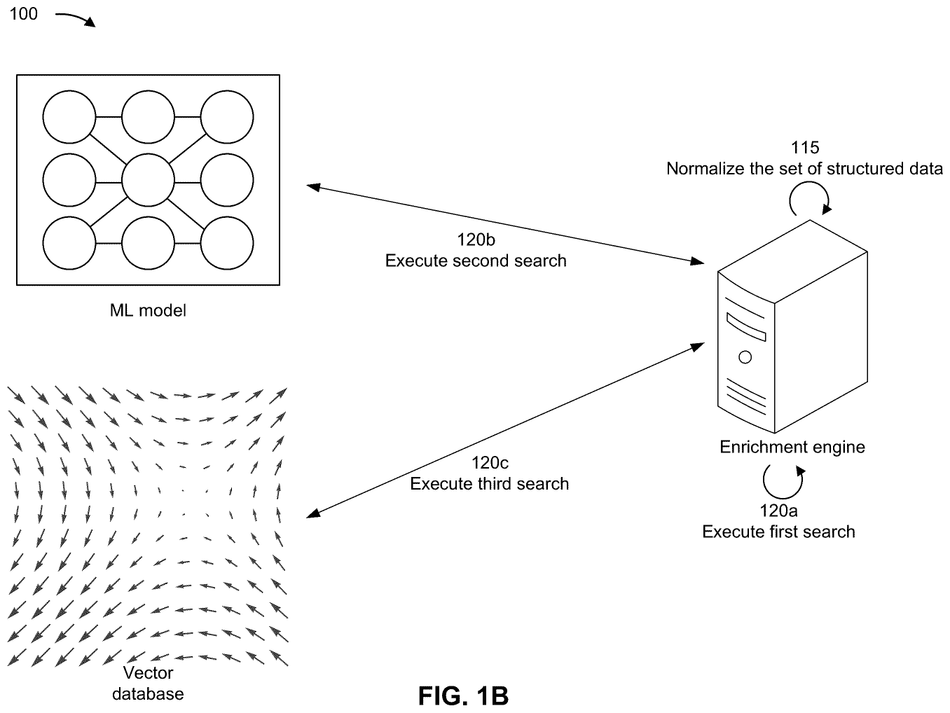

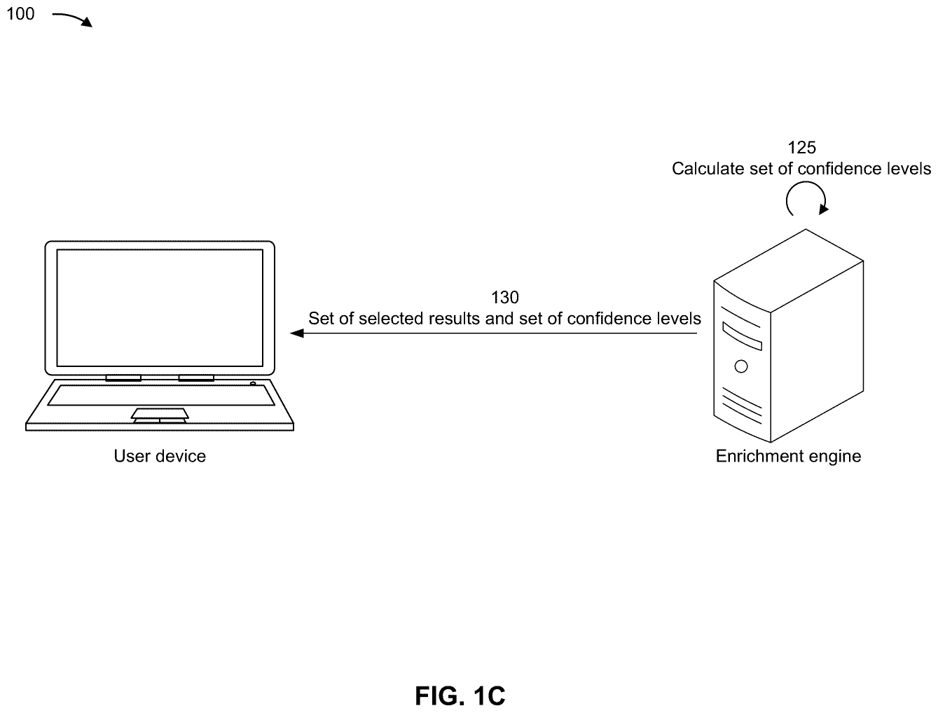

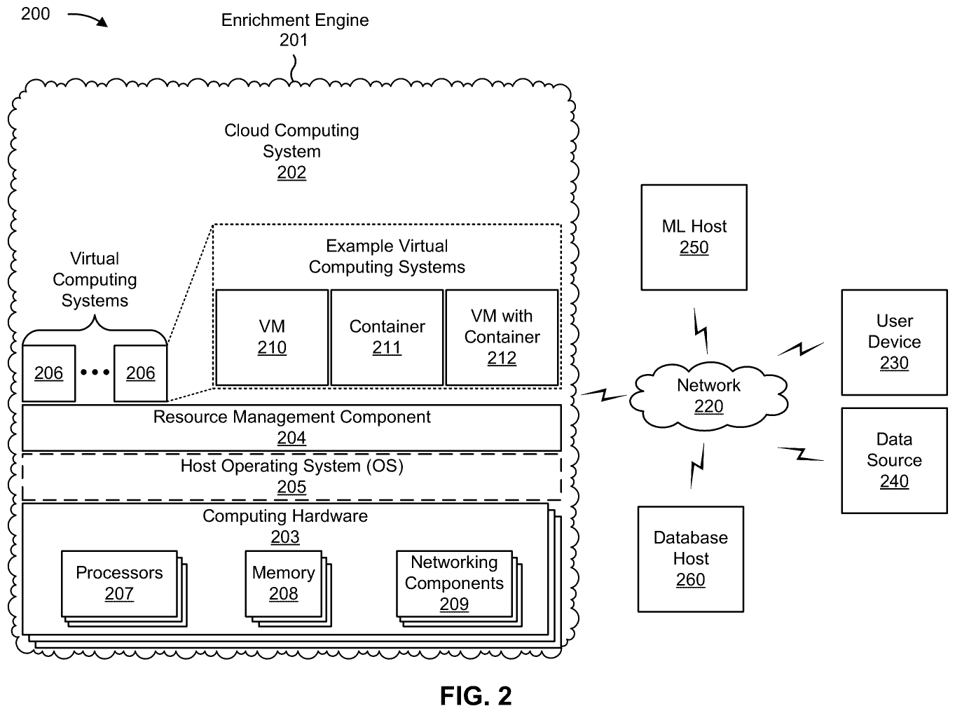

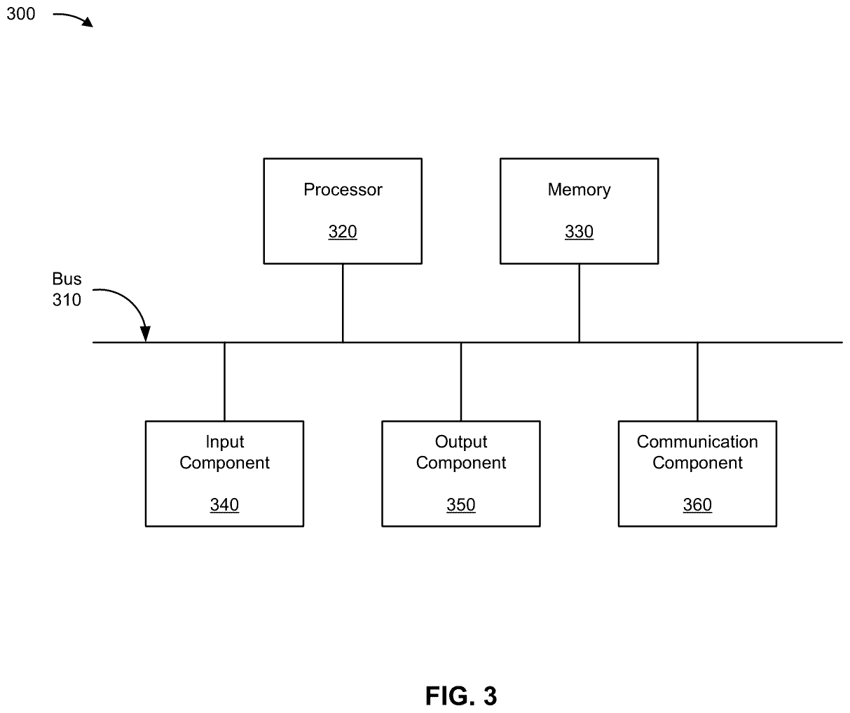

FIGS. 1A-1C are diagrams of an example 100 associated with data enrichment using parallel search. As shown in FIGS. 1A-1C, example 100 includes a user device, an enrichment engine, a data source, a machine learning (ML) model (e.g., provided by an ML host), and a vector database (e.g., provided by a database host). These devices are described in more detail in connection with FIGS. 2 and 3.

As shown in FIG. 1A and by reference number 105, the enrichment engine may provision an application programming interface (API) endpoint for the user device. For example, the enrichment engine may provision a/transactions/enhance endpoint. In some implementations, the enrichment engine may transmit, and the user device may receive, a set of credentials associated with the user device, such as an identifier and a secret and/or another type of access credentials. For example, the enrichment engine may provide a client_id parameter that identifies the user device and a secret parameter that functions as a password associated with the user device and that authorizes the user device to request the enrichment engine to enrich data (e.g., provided by the user device). The enrichment engine may generate the secret and expect to receive the secret in API calls from the user device. The secret may include a signature based on a private key associated with (e.g., via a key distribution center (KDC)) the user device.

As shown by reference number 110a, the user device may transmit, and the enrichment engine may receive, a set of structured data including a set of entries (e.g., transactions or another type of events). For example, the user device may call the API and include the set of structured data as a parameter (e.g., as a transactions parameter). Therefore, the user device may transmit, and the enrichment engine may receive, the set of structured data as input to the API.

Each entry in the set of structured data may include an identifier (e.g., an id parameter assigned by the user device or already included in the set of structured data), a string description (e.g., a description parameter), an amount (e.g., an amount parameter), and/or a currency code (e.g., an iso_currency_code using abbreviations from the International Standards Organization (ISO)), among other examples. In some implementations, the user device may further indicate a type of account associated with the set of structured data (e.g., a depository account or a credit account, captured in an account_type parameter). Therefore, the enrichment engine may determine whether to include some categories, as described below, based on the type of account (e.g., not using “wages” as a category for a credit account).

In some implementations, the user device may include a set of credentials associated with the user device, such as an identifier and a secret and/or another type of access credentials. For example, the user device may include the client_id parameter that identifies the user device and the secret parameter, as described above. Although the example 100 is described with the user device including the set of credentials with the set of structured data, other examples may include the user device authenticating with the enrichment engine before transmitting the set of structured data to the enrichment engine.

Additionally, or alternatively, as shown by reference number 110b, the data source may transmit, and the enrichment engine may receive, the set of structured data. For example, the enrichment engine may transmit (and the data source may receive) a request for the set of structured data, and the data source may transmit (and the enrichment engine may receive) the set of structured data in response to the request. The request may include a hypertext transfer protocol (HTTP) request, a file transfer protocol (FTP) request, and/or an API call. The request may include (e.g., in a header and/or as an argument) an indication of the set of structured data (e.g., a name, a filepath, and/or another type of alphanumeric identifier associated with the set of structured data). In some implementations, the indication of the set of structured data may be from the user device. For example, the user device may transmit, and the enrichment engine may receive, the indication (e.g., in a call to the API provisioned as described above), and the enrichment engine may transmit the request to the data source based on the indication.

In some implementations, the enrichment engine may include, in the request to the data source, a set of credentials that authorize the enrichment engine to access the set of structured data. For example, the set of credentials may include a key, a certificate, a signature, and/or another type of secret information that authenticates the request. Additionally, or alternatively, the enrichment engine may include, in the request to the data source, the set of credentials from the user device (e.g., the client_id parameter that identifies the user device and the secret parameter, as described above). Although the example 100 is described with the enrichment engine including the set of credentials with the request to the data source, other examples may include the enrichment engine authenticating with the data source before transmitting the request to the data source.

As shown in FIG. 1B and by reference number 115, the enrichment engine may normalize the set of structured data (e.g., by generating a set of normalized entries from the set of entries). In some implementations, the enrichment engine may generate normalized entries by using subword tokenization of the entries. For example, the enrichment engine may divide each entry into a plurality of subwords (e.g., based on spaces, commas, periods, and/or other delimiters) and may normalize each subword (in the plurality of subwords) to generate a normalized entry. To normalize each subword, the enrichment engine may apply standardized casing (e.g., all lower case or all upper case), whitespace stripping, and/or punctuation processing (e.g., by removing hyphens, dashes, pound symbols, asterisks, and/or other punction symbols) to each subword. Therefore, each normalized entry may include the normalized plurality of subwords. Additionally, or alternatively, the enrichment engine may divide each entry into a plurality of subwords and may divide each subword (in the plurality of subwords) into one or more tokens (e.g., by dividing numerical portions of a subword from alphabetic portions of the subword and/or by dividing subwords according to subject matter, such as dividing postal codes from cities and/or dividing state abbreviations from cities, among other examples). Therefore, each normalized entry may be generated based on the one or more tokens for each subword. In a combinatory example, the one or more tokens may be generated from a plurality of normalized subwords (e.g., generated as described above).

By pre-processing the set of structured data, the enrichment engine improves accuracy of the searches described below. Therefore, the enrichment engine uses power, processing resources, and memory overhead, associated with the searches, more efficiently. Additionally, the enrichment engine reduces latency associated with the searches because normalized entries are faster to process than raw entries.

As further shown in FIG. 1B, the enrichment engine may execute a plurality of searches concurrently (e.g., for each (normalized) entry in the set of structured data). As used herein, “concurrently” refers to events that are at least partially overlapping in time, even if start times and/or end times for the events differ from each other. The plurality of searches may further be in parallel. As used herein, “in parallel” may refer to events that start at approximately a same time (e.g., within a few microseconds of each other). Although the plurality of searches may be performed using multi-threading and/or multi-core execution, other techniques may also be used to execute the plurality of searches concurrently (and optionally in parallel).

As shown by reference number 120a, the enrichment engine may execute a first search configured to map, for each entry, a portion of the entry to a first result using regular expressions and fuzzy matching. The regular expressions may identify common patterns for transaction information (e.g., “[merchant name] [store id] [date] [location]” among other examples). The fuzzy matching may match the common patterns even if truncation, abbreviation, and/or misspellings (among other examples) are present. For example, the fuzzy matching may determine a match when a quantity or proportion of characters in the entry match the first result, and the quantity or proportion satisfies a fuzzy match threshold.

Although the example 100 shows the enrichment engine as performing the first search, other examples may include a third-party device performing the first search. For example, the enrichment engine may transmit (and the third-party device may receive) a request including the entry, and the third-party device may transmit (and the enrichment engine may receive) a response including the first result.

The first result may be associated with enhancement information for the entry. For example, a database (either integrated with the enrichment engine or at least partially separate from the enrichment engine, whether logically, virtually, and/or physically) may associate an identifier of the first result (e.g., an index and/or another type of identifier) with enhancement information for the entry. The enhancement information may include a standardized name (e.g., in a merchant_name parameter), a location indicator (e.g., in a location parameter, including an address parameter, a city parameter, a region parameter, a country parameter, a lat parameter, a lon parameter, and/or a store_number parameter), a category for the entry (e.g., in category, category_id, and/or personal_finance_category parameters), an identifier associated with the entry (e.g., in a check_number parameter), a type of location associated with the entry (e.g., an indication of in store, online, or other in a payment_channel parameter), a uniform resource locator (URL) associated with the entry, a corresponding image for the entry (e.g., a logo, a category image, and/or a capital letter), a standardized name associated with a counterparty for the entry, and/or a corresponding image for the counterparty. In some implementations, the enhancement information may additionally include an alphanumeric identifier generated by the enrichment engine for the entry (e.g., in an entity_id parameter).

As shown by reference number 120b, the enrichment engine may execute a second search (in parallel, or at least concurrently, with the first search) that is configured, for each entry, to provide the entry to the ML model in order to receive a second result. For example, the enrichment engine may transmit (and the ML host associated with the ML model may receive) a request including the entry, and the ML host may transmit (and the enrichment engine may receive) a response including the second result. The ML model may be trained (e.g., by the ML host and/or a device at least partially separate from the ML host) to determine enhancement information (e.g., as described above) for an entry in the set of structured data.

In some implementations, the underwriting model may include a regression algorithm (e.g., linear regression or logistic regression), which may include a regularized regression algorithm (e.g., Lasso regression, Ridge regression, or Elastic-Net regression). Additionally, or alternatively, the underwriting model may include a decision tree algorithm, which may include a tree ensemble algorithm (e.g., generated using bagging and/or boosting), a random forest algorithm, or a boosted trees algorithm. A model parameter may include an attribute of a model that is learned from data input into the model (e.g., the original dataset and the synthetic dataset). For example, for a regression algorithm, a model parameter may include a regression coefficient (e.g., a weight). For a decision tree algorithm, a model parameter may include a decision tree split location, as an example. In a testing phase, accuracy of the underwriting model may be measured without modifying model parameters. In a refinement phase, the model parameters may be further modified from values determined in an original training phase.

Additionally, the ML host (and/or a device at least partially separate from the ML host) may use one or more hyperparameter sets to tune the ML model. A hyperparameter may include a structural parameter that controls execution of a machine learning algorithm by the ML host, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the model. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

Other examples may use different types of models, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

As shown by reference number 120c, the enrichment engine may execute a third search (in parallel, or at least concurrently, with the second search) that is configured to map, for each entry, a vectorized version of the entry to a third result in the vector database. For example, the enrichment engine may transmit (and the database host associated with the vector database may receive) a request including the entry, and the database host may transmit (and the enrichment engine may receive) a response including the third result. The third result may be associated with enhancement information (e.g., as described above) for the entry.

In order to perform the third search, a vectorized version of each entry may be generated using an encoding space. For example, characters of the entry may be converted into numerical representations of the characters along a plurality of dimensions, and the numerical representations organized along the plurality of dimensions thus form the vectorized version of the entry. In one example, the enrichment engine may generate the vectorized version of the entry and may include the vectorized version in the request to the database host. In another example, the enrichment engine may include the entry in the request to the database host, and the database host may generate the vectorized version of the entry. The database host may select the third result based on a distance in the encoding space, between the vectorized version of the entry and a vectorized version of the third result, being a shortest distance as compared with distances between the vectorized version of the entry and other vectorized versions of possible results.

The enrichment engine may determine a selected result from the first result based on the first search, the second result based on the second search, or the third result based on the third search. For example, the first result may be associated with a first score (e.g., output by the regular expressions and/or the fuzzy matching), the second result is associated with a second score (e.g., output by the ML model), the third result is associated with a third score (e.g., output by the vector database), and the enrichment engine may determine the selected result by selecting from the first result, the second result, or the third result based on a highest score of the first score, the second score, or the third score.

In some implementations, the enrichment engine may calculate a confidence level associated with the selected result. For example, the confidence level may be the score associated with the selected result. Accordingly, as described above, the enrichment engine may receive a plurality of scores (the first score, the second score, and the third score) associated with a plurality of possible results (the first result, the second result, and the third result) and may select the confidence level as a score (from the plurality of scores) that is associated with the selected result (from the plurality of possible results). In some implementations, the confidence level may be a probability associated with the selected result.

Additionally, or alternatively, the enrichment engine may calculate the confidence level based on metadata from the regular expressions, the fuzzy matching, the ML model, and/or the vector database. In one example, the metadata may indicate which regular expression was satisfied (out of a plurality of regexes). Accordingly, the enrichment engine may assign a higher confidence level to some regexes and a lower confidence level to other regexes. In another example, the metadata may indicate a quantity or proportion of characters in the entry that were matched during the fuzzy matching. Accordingly, the enrichment engine may calculate a higher confidence level based on a greater quantity and/or proportion of characters being matched. In yet another example, the metadata may indicate a confidence score output by the ML model, and the enrichment engine may use the confidence score (or a normalized version of the confidence score) as the confidence level. In another example, the metadata may indicate a distance between (the vectorized version of) the entry and (the vectorized version of) the selected result in the vector database. Accordingly, the enrichment engine may calculate a higher confidence level based on a shorter distance between the entry and the selected result.

The enrichment engine may output the selected result (including enhancement information for the entry) and the confidence level (associated with the selected result). For example, the enrichment engine may transmit, and the user device may receive, the selected result and the confidence level (e.g., because the user device triggered the plurality of searches by performing an API call, as described above). The enrichment engine may return the selected result and the confidence level in response to the API call from the user device, as described above.

The operations described in connection with FIG. 1B may be repeated for each entry in the set of structured data. Therefore, the enrichment engine may determine a set of selected results, where each selected result in the set is associated with a corresponding entry in the set of structured data. Additionally, as shown in FIG. 1C and by reference number 125, the enrichment engine may calculate a set of confidence levels, where each confidence level is associated with a corresponding selected result in the set of selected results.

Furthermore, the enrichment engine may output a set of selected results (including enhancement information for each entry) and a set of confidence levels (associated with the set of selected results). For example, as shown by reference number 130, the enrichment engine may transmit, and the user device may receive, the set of selected results and the set of confidence levels (e.g., because the user device triggered the plurality of searches by performing an API call, as described above). The enrichment engine may return the set of selected results and the set of confidence levels in response to the API call from the user device, as described above.

By using techniques as described in connection with FIGS. 1A-1C, the enrichment engine performs the plurality of searches concurrently. As a result, accuracy of the set of selected results is improved. Additionally, the enrichment engine performing the plurality of searches is faster and more efficient as compared with the user device performing the plurality of searches. Furthermore, the enrichment engine performing the plurality of searches decreases latency in returning the enhancement information (for each entry in the set of structured data) to the user device.

As indicated above, FIGS. 1A-1C are provided as an example. Other examples may differ from what is described with regard to FIGS. 1A-1C.

FIG. 2 is a diagram of an example environment 200 in which systems and/or methods described herein may be implemented. As shown in FIG. 2, environment 200 may include a enrichment engine 201, which may include one or more elements of and/or may execute within a cloud computing system 202. The cloud computing system 202 may include one or more elements 203-212, as described in more detail below. As further shown in FIG. 2, environment 200 may include a network 220, a user device 230, a data source 240, an ML host 250, and/or a database host 260. Devices and/or elements of environment 200 may interconnect via wired connections and/or wireless connections.

The cloud computing system 202 may include computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from computing hardware 203 of the single computing device. In this way, computing hardware 203 can operate more efficiently, with lower power consumption, higher reliability, higher availability, higher utilization, greater flexibility, and lower cost than using separate computing devices.

The computing hardware 203 may include hardware and corresponding resources from one or more computing devices. For example, computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using computing hardware 203. As shown, a virtual computing system 206 may include a virtual machine 210, a container 211, or a hybrid environment 212 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

Although the enrichment engine 201 may include one or more elements 203-212 of the cloud computing system 202, may execute within the cloud computing system 202, and/or may be hosted within the cloud computing system 202, in some implementations, the enrichment engine 201 may not be cloud-based (e.g., may be implemented outside of a cloud computing system) or may be partially cloud-based. For example, the enrichment engine 201 may include one or more devices that are not part of the cloud computing system 202, such as device 300 of FIG. 3, which may include a standalone server or another type of computing device. The enrichment engine 201 may perform one or more operations and/or processes described in more detail elsewhere herein.

The network 220 may include one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The user device 230 may include one or more devices capable of receiving, generating, storing, processing, and/or providing information associated with structured data, as described elsewhere herein. The user device 230 may include a communication device and/or a computing device. For example, the user device 230 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 230 may communicate with one or more other devices of environment 200, as described elsewhere herein.

The data source 240 may include one or more devices capable of receiving, generating, storing, processing, and/or providing information associated with structured data, as described elsewhere herein. The data source 240 may include a communication device and/or a computing device. For example, the data source 240 may include a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data source 240 may communicate with one or more other devices of environment 200, as described elsewhere herein.

The ML host 250 may include one or more devices capable of receiving, generating, storing, processing, providing, and/or routing information associated with machine learning models, as described elsewhere herein. The ML host 250 may include a communication device and/or a computing device. For example, the ML host 250 may include a server, such as an application server, a client server, a web server, a database server, a host server, a proxy server, a virtual server (e.g., executing on computing hardware), or a server in a cloud computing system. In some implementations, the ML host 250 may include computing hardware used in a cloud computing environment. The ML host 250 may communicate with one or more other devices of environment 200, as described elsewhere herein.

The database host 260 may include one or more devices capable of receiving, generating, storing, processing, and/or providing information associated with vectorized representations, as described elsewhere herein. The database host 260 may include a communication device and/or a computing device. For example, the database host 260 may include a server, a database server, an application server, a client server, a web server, a host server, a proxy server, a virtual server (e.g., executing on computing hardware), a server in a cloud computing system, a device that includes computing hardware used in a cloud computing environment, or a similar type of device. The database host 260 may communicate with one or more other devices of environment 200, as described elsewhere herein.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300 associated with data enrichment using parallel search. The device 300 may correspond to a user device 230, a data source 240, an ML host 250, and/or a database host 260. In some implementations, a user device 230, a data source 240, an ML host 250, and/or a database host 260 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

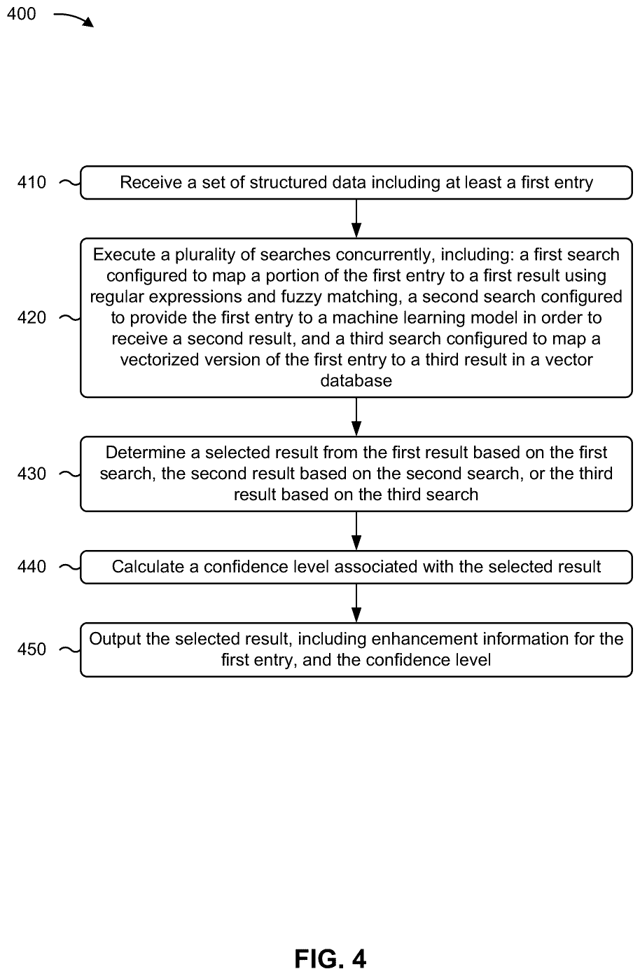

FIG. 4 is a flowchart of an example process 400 associated with data enrichment using parallel search. In some implementations, one or more process blocks of FIG. 4 may be performed by an enrichment engine 201. In some implementations, one or more process blocks of FIG. 4 may be performed by another device or a group of devices separate from or including the enrichment engine 201, such as a user device 230, a data source 240, an ML host 250, and/or a database host 260. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving a set of structured data including at least a first entry (block 410). For example, the enrichment engine 201 (e.g., using processor 320, memory 330, and/or communication component 360) may receive a set of structured data including at least a first entry, as described above in connection with reference number 110a or reference number 110b of FIG. 1A.

As further shown in FIG. 4, process 400 may include executing a plurality of searches concurrently, including: a first search configured to map a portion of the first entry to a first result using regular expressions and fuzzy matching, a second search configured to provide the first entry to a machine learning model in order to receive a second result, and a third search configured to map a vectorized version of the first entry to a third result in a vector database (block 420). For example, the enrichment engine 201 (e.g., using processor 320, memory 330, and/or communication component 360) may execute a plurality of searches concurrently, as described above in connection with FIG. 1B.

As further shown in FIG. 4, process 400 may include determining a selected result from the first result based on the first search, the second result based on the second search, or the third result based on the third search (block 430). For example, the enrichment engine 201 (e.g., using processor 320 and/or memory 330) may determine a selected result from the first result based on the first search, the second result based on the second search, or the third result based on the third search, as described above in connection with FIG. 1B.

As further shown in FIG. 4, process 400 may include calculating a confidence level associated with the selected result (block 440). For example, the enrichment engine 201 (e.g., using processor 320 and/or memory 330) may calculate a confidence level associated with the selected result, as described above in connection with reference number 125 of FIG. 1C.

As further shown in FIG. 4, process 400 may include outputting the selected result, including enhancement information for the first entry, and the confidence level (block 450). For example, the enrichment engine 201 (e.g., using processor 320, memory 330, and/or communication component 360) may output the selected result, including enhancement information for the first entry, and the confidence level, as described above in connection with reference number 130 of FIG. 1C.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1C.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for data enrichment using a plurality of searches in parallel, the system comprising:
one or more memories; and
one or more processors, communicatively coupled to the one or more memories, configured to:
receive a set of structured data including at least a first entry;
execute the plurality of searches concurrently, wherein the plurality of searches comprises:
a first search configured to map a portion of the first entry to a first result using regular expressions and fuzzy matching;
a second search configured to provide the first entry to a machine learning model in order to receive a second result; and
a third search configured to map a vectorized version of the first entry to a third result in a vector database;
determine a selected result from the first result based on the first search, the second result based on the second search, or the third result based on the third search;
calculate a confidence level associated with the selected result; and
output the selected result, including enhancement information for the first entry, and the confidence level.

2. The system of claim 1, wherein the set of structured data further includes a second entry, and the one or more processors are configured to:
execute the plurality of searches concurrently for the second entry;
determine an additional selected result for the second entry;
calculate an additional confidence level associated with the additional selected result; and
output the additional selected result, including enhancement information for the second entry, and the additional confidence level.

3. The system of claim 1, wherein the one or more processors, to execute the second search, are configured to:
transmit a request including the first entry to a database host associated with the vector database; and
receive the third result from the database host in response to the request.

4. The system of claim 1, wherein the one or more processors, to execute the third search, are configured to:
transmit a request including the first entry to a machine learning host associated with the machine learning model; and
receive the second result from the machine learning host in response to the request.

5. The system of claim 1, wherein the one or more processors, to determine the selected result, are configured to:
determine the selected result based on the confidence level.

6. The system of claim 1, wherein the confidence level comprises a probability associated with the selected result.

7. The system of claim 1, wherein the one or more processors, to output the selected result and the confidence level, are configured to:
transmit the selected result and the confidence level to a device that triggered the plurality of searches by performing an application programming interface call.

8. The system of claim 1, wherein the set of structured data comprises transaction information.

9. A method of data enrichment using a plurality of searches in parallel, comprising:
receiving, at an enrichment engine, a set of structured data including at least a first entry;
generating a normalized first entry by using subword tokenization of the first entry;
executing, by the enrichment engine, the plurality of searches concurrently, wherein the plurality of searches comprises:
a first search configured to map a portion of the normalized first entry to a first result using regular expressions and fuzzy matching;
a second search configured to provide the normalized first entry to a machine learning model in order to receive a second result; and
a third search configured to map a vectorized version of the normalized first entry to a third result in a vector database;
determining, by the enrichment engine, a selected result from the first result based on the first search, the second result based on the second search, or the third result based on the third search; and
returning the selected result including enhancement information for the first entry.

10. The method of claim 9, wherein receiving the set of structured data comprises:
receiving the set of structured data from a user device as input to an application programming interface.

11. The method of claim 9, wherein receiving the set of structured data comprises:
transmitting, to a data source, a request for the set of structured data; and
receiving the set of structured data in response to the request.

12. The method of claim 9, wherein the first result is associated with a first score, the second result is associated with a second score, the third result is associated with a third score, and determining the selected result comprises:
selecting from the first result, the second result, or the third result based on a highest score of the first score, the second score, or the third score.

13. The method of claim 9, wherein receiving the set of structured data comprises:
receiving an indication of the set of structured data from a user device; and
receiving the set of structured data from a data source based on the indication.

14. The method of claim 13, further comprising:
receiving a set of credentials from the user device,
wherein the set of structured data is received using the set of credentials.

15. A non-transitory computer-readable medium storing a set of instructions for data enrichment, the set of instructions comprising:
one or more instructions that, when executed by one or more processors of a device, cause the device to:
receive a set of structured data including at least a first entry;
generate a normalized first entry by using subword tokenization of the first entry;
determine a selected result, with enhancement information for the first entry, using one or more of regular expressions, fuzzy matching, or a machine learning model;
calculate a confidence level associated with the selected result; and
return the selected result, including the enhancement information, and the confidence level.

16. The non-transitory computer-readable medium of claim 15, wherein the one or more instructions, that cause the device to generate the normalized first entry, cause the device to:
divide the first entry into a plurality of subwords; and
normalize each subword in the plurality of subwords to generate the normalized first entry.

17. The non-transitory computer-readable medium of claim 16, wherein the one or more instructions, that cause the device to normalize each subword, cause the device to:
apply standardized casing, whitespace stripping, and punctuation processing to each subword.

18. The non-transitory computer-readable medium of claim 15, wherein the one or more instructions, that cause the device to generate the normalized first entry, cause the device to:
divide the first entry into a plurality of subwords;
divide each subword in the plurality of subwords into one or more tokens; and
generate the normalized first entry based on the one or more tokens for each subword.

19. The non-transitory computer-readable medium of claim 15, wherein the one or more instructions, that cause the device to calculate the confidence level, cause the device to:
receive a plurality of possible results associated with a plurality of scores; and
select the confidence level, from the plurality of scores, associated with the selected result from the plurality of possible results.

20. The non-transitory computer-readable medium of claim 15, wherein the one or more instructions, that cause the device to calculate the confidence level, cause the device to:
calculate the confidence level based on metadata from the one or more of the regular expressions, the fuzzy matching, or the machine learning model.
